(19) United States
(12) Patent Application Publication
(10) Pub. No.: US 2014/0306998 A1
(43) Pub. Date: Oct. 16, 2014

(54) COMPUTER-READABLE RECORDING MEDIUM, METHOD, AND TERMINAL APPARATUS FOR DISPLAYING LAND BOUNDARY

(71) Applicant: FUJITSU LIMITED, Kawasaki-shi (JP)

(72) Inventor: Yutaka Moriya, Sagamihara (JP)

(73) Assignee: FUJITSU LIMITED, Kawasaki-shi (JP)

(21) Appl. No.: 14/247,927

(22) Filed: Apr. 8, 2014

(30) Foreign Application Priority Data
Apr. 16, 2013 (JP) 2013-085904

(51) Int. Cl. G09G 5/377; G06Q 50/16

(52) U.S. Cl. CPC G09G 5/377; G06Q 50/16; G09G 2340/12
USPC 345/634

(57) ABSTRACT

A computer is disclosed that performs a land boundary display process. The computer executes an imaging process when an imaging request is detected. The computer specifies an imaging range based on a location, an imaging orientation and an elevation angle of a terminal apparatus when the imaging process is executed. Also, the computer specifies an area corresponding to a plot of land in a captured imaged based on the imaging range being specified. After that, the computer reads out boundary line information of the plot of land corresponding to latitude and longitude information from a storage part, and generates an image by overlapping an area corresponding to the plot of land being specified with the boundary line information being read out. Then, the computer displays the image at a display device.

### CROSS-REFERENCE TO RELATED APPLICATIONS

This patent application is based upon and claims the benefit of priority of the prior Japanese Patent Application No. 2013-085904 filed on Apr. 16, 2013, the entire contents of which are incorporated herein by reference.

### FIELD

The embodiment discussed herein is related to a technology for displaying a land boundary.

### BACKGROUND

Conventionally, in order to indicate information pertinent to real estate such as the place (location), the shape, an address, or the occupants of a land or a building, there is a method for depicting the information on a plan view such as a map or the like.

According to a conventional method, in a case in which a surveyor conducts a field survey and the like of the real estate and specifies the real estate at a location, first, the surveyor attempts to associate a target on the plan view such as the map with an actual target existing at the location. Second, the surveyor reads a relative location, a distance, and the like to the target. Then, the surveyor actually measures the distance or the like at the location, and specifies the real estate.

For instance, a technology is presented in which a map stipulated in the Japanese Article 17 of the Real Estate Registration Act is used as a reference map. In this technology, figures (so-called “public figures”) stipulated in the Article 24 Section 3 Real Estate Registration Act are used for areas which do not exist on the reference map. Then, map data, in which information pertinent to each of the blocks adjusted for the current state, are output.

However, there is the following problems related to the above described technology.

First, in order to specify the real estate at the location, the surveyor needs to have knowledge for associating the plan view with the target on the map. Also, in order to specify the real estate, the surveyor needs to measure the relative location, the distance, and the like.

Second, in a case of using a mobile terminal, in order to display the plan view at the mobile terminal, a display system for the plan view and information of the plan view are needed. In addition, the fee to use a map such as a contrast map representing an address and residence by colors may be expensive.

### Patent Documents

Japanese Laid-open Patent Publication No. 2004-191466

### SUMMARY

According to one aspect of the embodiment, there is provided a non-transitory computer-readable recording medium storing a program which, when executed by a computer, causes the computer to perform a land boundary display process including: executing an imaging process when an imaging request is detected; specifying an imaging range based on a location, an imaging orientation and an elevation angle of a terminal apparatus when the imaging process is executed; specifying an area corresponding to a plot of land in a captured imaged based on the imaging range being specified; reading out boundary line information of the plot of land corresponding to latitude and longitude information from a storage part; generating an image by overlapping an area being specified with the boundary line information being read out; and displaying the image at a display device.

According to other aspect of the embodiment, there may be provided a land boundary display method, a terminal apparatus, and a system, in light of displaying the land boundary.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram for illustrating a configuration example of a system in embodiments;

FIG. 2 is a diagram illustrating a hardware configuration of a terminal apparatus;

FIG. 3 is a diagram illustrating a state example in which a target is photographed by the terminal apparatus;

FIG. 4 is a diagram illustrating the hardware configuration of a server apparatus;

FIG. 5 is a diagram illustrating a functional configuration example of the terminal apparatus in an Embodiment 1;

FIG. 6 is a diagram illustrating a functional configuration example of the server apparatus in the Embodiment 1;

FIG. 7 is a flowchart for explaining a process until the terminal apparatus requests the server apparatus map data in the Embodiment 1 (part 1);

FIG. 8 is a flowchart for explaining a process until the server apparatus transmits the map data in response to a map data request in the Embodiment 1 (part 2);

FIG. 9 is a flowchart for explaining a process until the terminal apparatus sends the map data in response to the map data request in the Embodiment 1 (part 3);

FIG. 10 is a diagram illustrating a functional configuration example of a terminal apparatus in an Embodiment 2;

FIG. 11 is a diagram illustrating a functional configuration example of a server apparatus in the Embodiment 2;

FIG. 12 is a flowchart for explaining a process until the terminal apparatus requests the server apparatus map data in the Embodiment 2 (part 1);

FIG. 13 is a flowchart for explaining a process until the server apparatus sends the map data in response to the map data request in the Embodiment (part 2);

FIG. 14 is a flowchart for explaining a process until the terminal apparatus sends the map data in response to the map data request in the Embodiment 2 (part 3);

FIG. 15 is a diagram illustrating an example of a plan view;

FIG. 16 is a diagram illustrating an example of a birds-eye view;

FIG. 17A and FIG. 17B are diagrams illustrating example results of a real estate information overlapping process with respect to a close view in front of a user at the same location;

FIG. 18A and FIG. 18B are diagrams illustrating example results of the real estate information overlapping process with respect to another close view when a user looks back at the same location; and

FIG. 19A and FIG. 19B are diagrams illustrating example results of the real estate information overlapping process with respect to the distant view in front of the user at the same location.

### DESCRIPTION OF EMBODIMENTS

In the following, embodiments of the present invention will be described with reference to the accompanying drawings.

In the embodiments described below, technologies will be presented to display a boundary of a plot of land on an image photographed by a terminal apparatus having an image function.

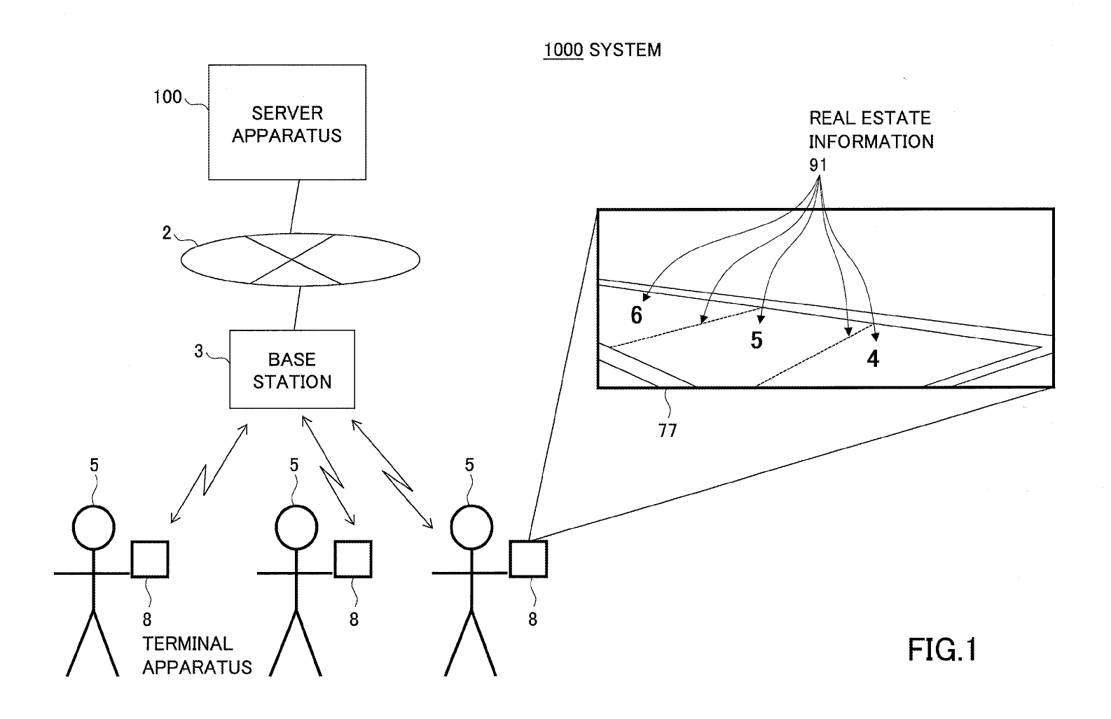

FIG. 1 is a diagram for illustrating a configuration example of a system in embodiments described later. A system 1000 depicted in FIG. 1 includes multiple terminal apparatuses 8 such as mobile terminals, and a server apparatus 100. Each of the terminal apparatuses 8 is connected to the server apparatus 100 through an Internet 2 from a base station 3 by wireless communication with the base station 3.

A terminal apparatus 8 may be a mobile terminal or the like which includes an imaging function such as a digital camera. The terminal apparatus 8 is possessed by a user 5, and sends the server apparatus 100 a request which includes target location information indicating a location of the user 5, a direction with respect to the target from the user 5, and the like when the user 5 takes a picture of the target. The target may be a plot of land, a building, or the like. The terminal apparatus 8 receives map data 77 from the server apparatus 100 in response to a map data request. The terminal apparatus 8 overlaps a captured image of the target with the map data 77 which are reduced and to which a perspective adjustment is performed, and displays an overlapped image at a display part.

When receiving the map data request including the target location information from the terminal apparatus 8, the server apparatus 100 sends the map data 77 including multiple sets of real estate information 91 and location information thereof based on the target location information, to the terminal apparatus 8 in response to the map data request. Each of the multiple sets of the real estate information 91 includes an address, latitude and longitude information of a plot of land specified by the address, a boundary line (parcel boundary line) information of the plot of land, and the like.

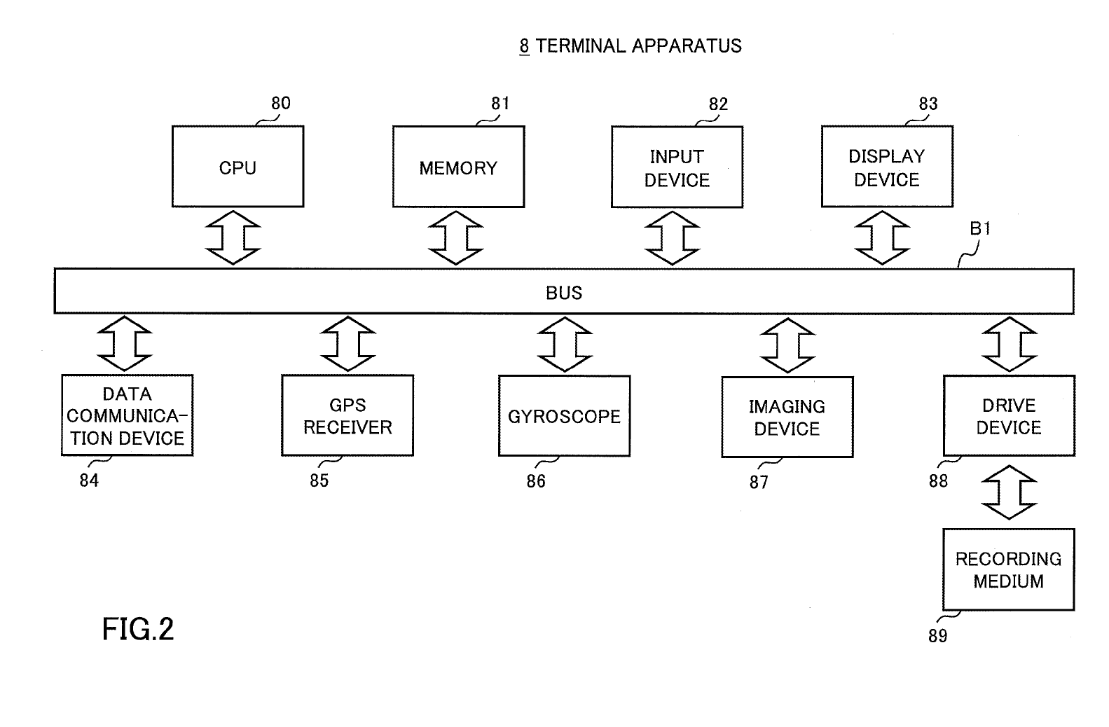

The terminal apparatus 8 may include a hardware configuration as illustrated in FIG. 2. FIG. 2 is a diagram illustrating the hardware configuration of the terminal apparatus. In FIG. 2, the terminal apparatus 8 may include a processor such as a Central Processing Unit (CPU) 80, a memory 81, an input device 82, a display device 83, a data communication device 84, a Global Positioning System (GPS) receiver 85, a gyroscope 86, an imaging device 87, and a drive device 88, which are mutually connected via a bus B1.

The CPU 80 controls the terminal apparatus 8 in accordance with a program stored in the memory 81. The memory 81 may include a Random Access Memory (RAM) and a Read-Only Memory (ROM), and store the program executed by the CPU 80, data for a process by the CPU 80, data acquired in the process by the CPU 80. Also, a part of the memory 81 is assigned as a working area used for the process by the CPU 80. The memory 81 corresponds to a storage part of the terminal apparatus 8.

The input device 82 may include keys to input English letters, numbers, Japanese letters, and the like, function keys to operate an application of the terminal apparatus 8. The display device 83 displays various informational items under a control of the CPU 80. The display device 83 displays an image in which a picture of the target taken by the imaging device 87 is overlapped with the map data 77 received from the server apparatus 100. In a case in which the display device 83 may be formed by a touch panel sensor, software keys may be displayed. In this case, the input device 82 may not be included in the terminal apparatus 8.

The data communication device 84 controls data communications via the base station 3. The terminal apparatus 8 communicates with the server apparatus 100 by the data communication part 84. The GPS receiver 85 receives terminal location information at predetermined intervals, and updates the terminal location information in a predetermined storage area in the memory 81.

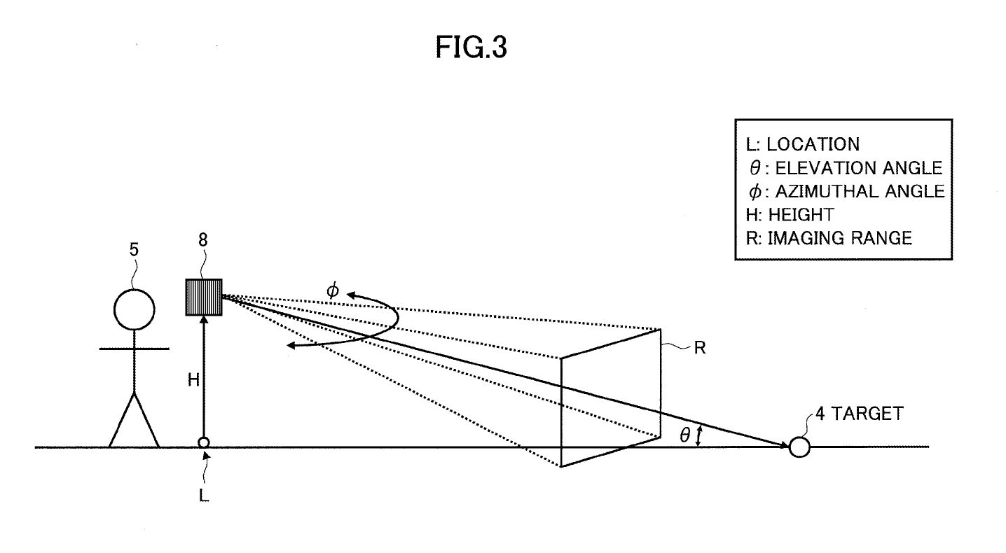

The gyroscope 86 detects an inclination of the terminal apparatus 8 and measures the inclination. When the user 5 takes a picture of a target 4 (FIG. 3) by the imaging device 87, the gyroscope 86 detects the inclination of the terminal apparatus 8, the gyroscope 86 measures an elevation angle θ and an azimuthal angle φ (FIG. 3), and stores elevation angle information indicating the elevation angle θ and azimuthal angle information indicating an azimuthal angle φ in a predetermined storage area in the memory 81. The imaging device 87 takes a picture in response to an operation of the user 5 and stores a captured image in the memory 81.

The program, which realizes the process according to the embodiments conducted by the terminal apparatus 8, may be downloaded from a provider by data communications in response to the operation of the user 5, is stored in the memory 81. Instead, the program may be stored beforehand in the memory 81 when the terminal apparatus 8 is shipped from a manufacturer.

Also, the program may be provided to the terminal apparatus 8 by a recording medium 89 which may be a flash memory card such as a micro Secure Digital (SD) memory card or the like. In this case, the program stored in the recording medium 89 is installed into the terminal apparatus 8 through the drive device 88 so that the installed program is capable of being executed by the terminal apparatus 8.

FIG. 3 is a diagram illustrating a state example in which the target is photographed by the terminal apparatus. In FIG. 3, a state, in which the user 5 takes a picture of the target 4 by using the terminal apparatus 8, is illustrated.

The terminal location information, which indicates a location L of the terminal apparatus 8 acquired by the GPS receiver 85, is stored in the memory 81 at predetermined intervals. Hence, it is possible to acquire the terminal location information of the terminal apparatus 8 in a state, in which the imaging device 87 photographs the target 4, from the memory 81. The terminal apparatus 8 is inclined when the user 5 takes a picture by using the imaging device 87. At this moment, the gyroscope 86 measures and stores the elevation angle θ and an azimuthal angle φ in the memory 81.

Height H corresponds to height of the terminal apparatus 8. The Height H may indicate height of the user 5 or height of the eyes of the user 5 which is set by the user 5. An imaging range R may correspond to a visual field of the user 5 looking at the target 4 from a display range of the display device 83 of the terminal apparatus 8.

As described above, when the target 4 is photographed by the terminal apparatus 8, it is possible to acquire the terminal location information, the elevation angle information, the azimuthal angle information, height information, imaging range information, and the like. The terminal apparatus 8 creates the target location information from the acquired information, and sends the target location information to the server apparatus 100. The server apparatus 100 sends the map data 77 to the terminal apparatus 8. The map data 77 include the real estate information 91 and display information which correspond to the target location information.

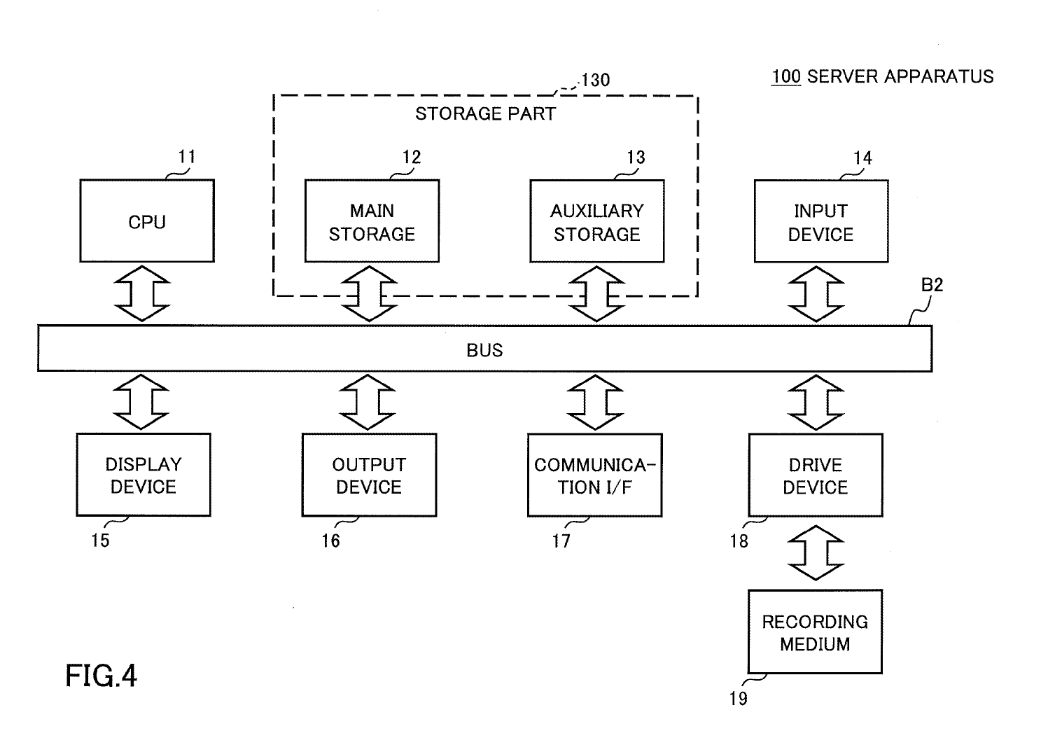

A server apparatus 100 includes a hardware configuration as illustrated in FIG. 4. FIG. 4 is a diagram illustrating the hardware configuration of the server apparatus. In FIG. 4, the server apparatus 100 is considered as an apparatus controlled by a computer, and includes a processor such as a Central Processing Unit (CPU) 11, a main storage 12, an auxiliary storage 13, an input device 14, a display device 15, an output device 16, a communication interface (I/F) 17, and a drive device 18, which are mutually connected via a bus B2.

The CPU 11 controls the server apparatus 100 in accordance with the program stored in the main storage 12. A Random Access Memory (RAM) and the like may be used as the main storage 12. The main storage 12 stores a program executed by the CPU 11, data for a process conducted by the CPU 11, data acquired in the process conducted by the CPU 11, and the like. Also, a part of the main storage 12 may be assigned as a working area used for the process conducted by the CPU 11.

The auxiliary storage 13 may include a hard disk drive. The auxiliary storage 13 stores the program and data to conduct various processes. A part of the program stored in the auxiliary storage 13 is loaded into the main storage 12. The various processes are performed by the CPU 11 executing the program. The main storage 12 and/or the auxiliary storage 13 correspond to a storage part 130 as a storage unit.

The input device 13 may include a mouse, a keyboard, and the like, and is used for an administrator to input various informational items for a process conducted by the server apparatus 100. The display device 15 displays various informational items under control of the CPU 11. The output device 16 may include a printer and the like. The output device 16 outputs various informational items in response to an instruction of the administrator. The communication I/F corresponds to an device which connects to an Internet, a Local Area Network (LAN), or the like and controls communications with an external apparatus. The communications via the communication I/F 17 may not be limited to wireless or wired communication.

The program, which realizes the process conducted by the server apparatus 100, may be provided to the server apparatus 100 by a recording medium 19 such as Compact Disc Read-Only Memory (CD-ROM) or the like. The recording medium 19 may be formed by a non-transitory (or tangible) computer-readable recording medium. The recording medium 19 storing the program is installed into the auxiliary storage 13 of the server apparatus 100. The program installed into the auxiliary storage 13 is executable by the server apparatus 100.

The recording medium 19 storing the program is not limited to the CD-ROM. Any computer-readable medium may be used as the recording medium 19. As the computer-readable recording medium, a portable recording medium such as a Digital Versatile Disk (DVD), a Universal Serial Bus (USB) memory, and a semiconductor memory such as a flash memory may be used as well as the CD-ROM.

In the embodiments described later, image data captured by the imaging device 87 and the map data 77 acquired from the server apparatus 100 are overlapped and displayed at the terminal apparatus 8. The boundary line (parcel boundary line) of the plot of land is depicted on the captured image. Also, the address is depicted on the captured image. The real estate information includes information of the parcel boundary line and the address.

A functional configuration in an Embodiment 1 for overlapping the real estate information with the captured image will be described. In the Embodiment 1, coordinates calculation of the target 4 photographed by the terminal apparatus 8 is performed by the terminal apparatus 8.

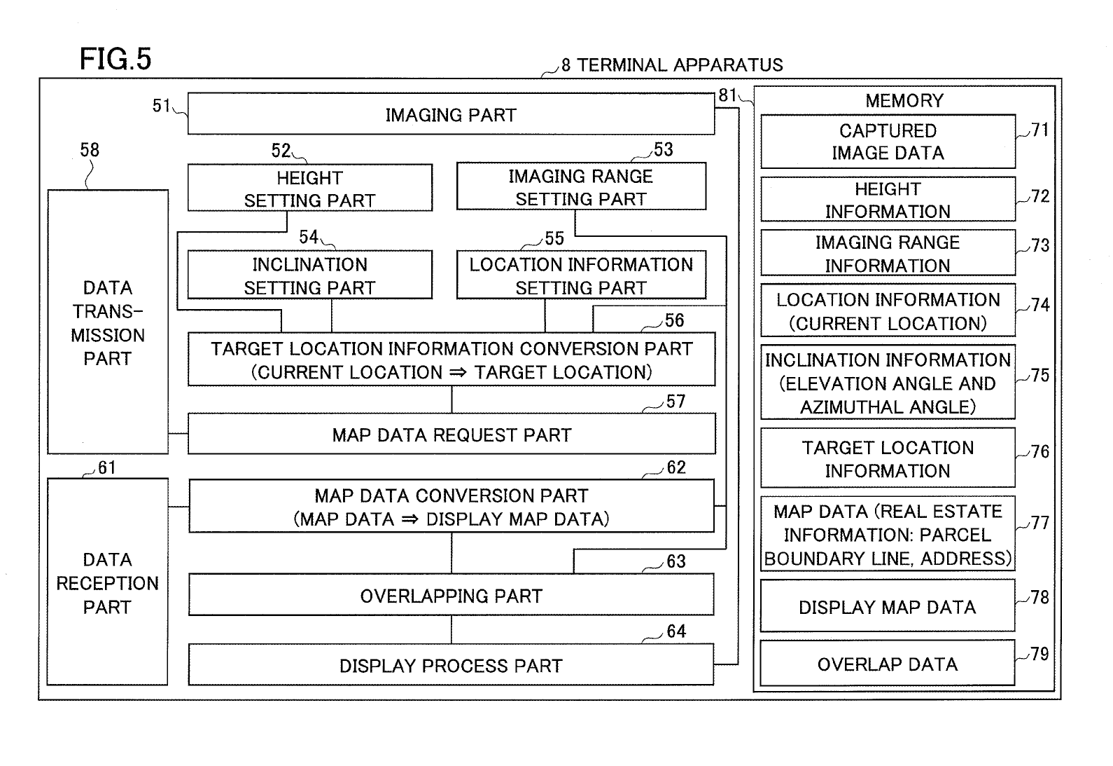

FIG. 5 is a diagram illustrating a functional configuration example of the terminal apparatus in the Embodiment 1. In FIG. 5, the terminal apparatus 8 includes an imaging part 51, a height setting part 52, an imaging range setting part 53, an inclination setting part 54, a location information setting part 55, a target location information conversion part 56 (current location->target location), a map data request part 57, a data transmission part 58, a data reception part 61, a map data conversion part 62 (map data->display map data), an overlapping part 63, and a display process part 64.

The memory 81 stores captured image data 71, height information 72, imaging range information 73, location information 74 (for current location), inclination information 75 (for the elevation angle and the azimuthal angle), target location information 76, the map data 77 (for real estate information indicating the parcel boundary line and the address), display map data 78, overlap data 79, and the like.

The imaging part 51 stores the captured image data 71 which are acquired by taking the picture of the target 4 in response to an operation of the user 5 with respect to the imaging device 87.

The height setting part 52 acquires the height information 72 from the memory 81 and sets the height information 72 to the target location information conversion part 56. The height information 72 is set beforehand by the user 5 and indicates the height H from the ground. In order to store the height information 72 in the memory 81, the height setting part 52 displays a user interface for the user 5 to set the height H from the ground to a position of the terminal apparatus 8 at the display device 83, acquires a distance from the ground to the eyes of the user 5 or the height of the user 5 from the user 5, and stores the height information 72 in the memory 81.

The imaging range setting part 53 stores, in response to photographing the target 4, the imaging range information 73 indicating the imaging range R corresponding to the visual field in a case in which the user 5 looks at the target 4 from the display part 83 of the terminal apparatus 8. Then, the imaging range setting part 53 sets the target location information conversion part 56, the map data conversion part 62, and the overlapping part 63.

When the imaging part 51 photographs the target 4, the inclination setting part 54 acquires the inclination information 75 which is measured by the gyroscope 86 and stored in the memory 81, and sets the inclination information 75 to the target location information conversion part 56. The inclination information 75 indicates the elevation angle θ and the azimuthal angle φ of the terminal apparatus 8.

When the imaging part 51 photographs the target 4, the location information setting part 55 acquires the location information 74 of the terminal apparatus 8 which is received from the GPS receiver 85 and stored in the memory 81, and sets the location information 74 to the target location information conversion part 56.

The target location information conversion part 56 calculates location coordinates of the target 4 by using the height information 72 and the location information 74 of the terminal apparatus 8, and the inclination information 75 acquired when the imaging part 51 photographs the target 4, in order to convert into the target location information 76 indicating a location of the target 4 from a current location of the terminal apparatus 8.

Alternatively, the target location information conversion part 56 may instruct the map data request part 57 to set the imaging range information 73 in the map data request. Otherwise, the target location information conversion part 56 may calculate a map data range corresponding to the imaging range R in which the target 4 positions at a center based on the imaging range information 73, and set the map data range in the map data request.

In a case in which the server apparatus 100 determines the map data range based on a predetermined range in which the target 4 is positioned at the center, it is possible to omit setting the map data range or the imaging range information 73 in the map data request. That is, any of the map data range and the imaging range information 73 may not be reported to the server apparatus 100.

The map data request part 57 creates the map data request including the target location information 76 acquired by the target location information conversion part 56, and sends the data transmission part 58 to the server apparatus 100.

The data transmission part 58 sends the map data request created by the map data request part 57 to the server apparatus 100.

The data reception part 61 receives the map data 77 from the server apparatus 100 in response to the map data request. The map data 77 include the real estate information 91. The real estate information 91 includes the parcel boundary line, the address, and the like.

The map data conversion part 62 specifies an area of the plot of land corresponding to the imaging range R based on the imaging range information 73, and conducts the perspective adjustment with respect to the map data 77 received by the data reception part 61 to display the specified area for the plot of land, so as to convert from the map data 77 to the display map data 78.

The overlapping part 63 acquires the captured image data 77 from the memory 81, and generates overlap data 79 in which the captured image data 77 are overlapped with the display map data 78, which are generated by the map data conversion part 62. The overlap data 79 is stored in the memory 81. By overlapping the captured image data 77 with the display map data 78, information of the parcel boundary line (the boundary line of the plot of land), which corresponds to the latitude and longitude information acquired from the map data 77 being stored in the memory 81, and the like are overlapped with an image of the area corresponding to the plot of land for each of addresses.

The display process part 64 acquires the overlap data 79 from the memory 81 and displays the overlap data 79 at the display part 83.

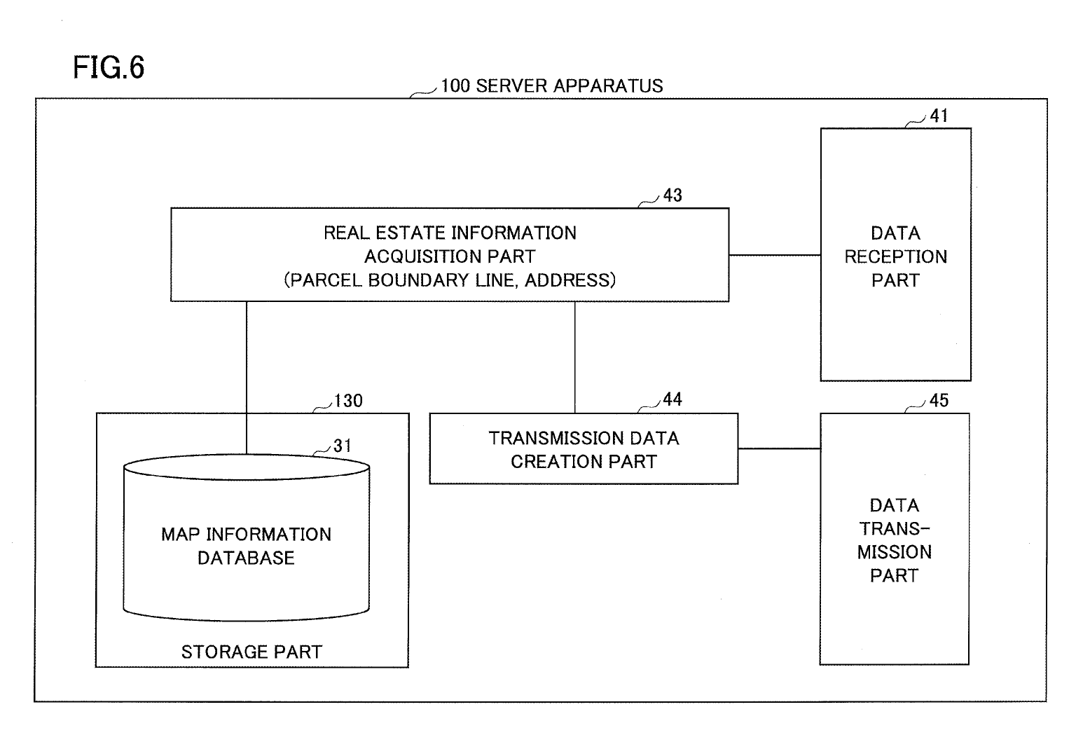

FIG. 6 is a diagram illustrating a functional configuration example of the server apparatus in the Embodiment 1. In FIG. 6, the server apparatus 100 includes a data reception part 41, a real estate information acquisition part 43, a transmission data creation part 44, and a data transmission part 45. The storage part 130 stores a map information database 31.

The data reception part 41 receives the map data request from the terminal apparatus 8 and reports the map data request to the real estate information acquisition part 43.

The real estate information acquisition part 43 acquires the parcel boundary line and the address from the map information database 31 which are stored beforehand in the storage part 130, based on the target location information 76 included in the map data request.

The map data range to acquire may be indicated by the map data request, and the map data may be acquired based on the map data range. If the map data range is indicated by the map data request, it is possible to acquire the map data concerning the target 4 and a peripheral of the target 4 by using the map data range which is defined beforehand. The real estate information acquisition part 43 reports the real estate information to the transmission data creation part 44 and requests the transmission data creation part 44 to transmit the real estate information. The real estate information may indicate the parcel boundary line or the address, or the both.

The transmission data creation part 44 creates the map data 77 which are processed to send the reported real estate information, and instructs the data transmission part 45 to send the map data 77.

The data transmission part 45 sends the map data 77 created by the transmission data creation part 44, to the terminal apparatus 8 in response to the map data request.

The map information database 31 may be built to indicate the address and the parcel boundary line (the boundary line between the addresses) at least. Preferably, the map information database 31 corresponds to a database of map information which is regulated to retain in a plot of land registry by the Japanese Article 17 of the Real Estate Registration Act.

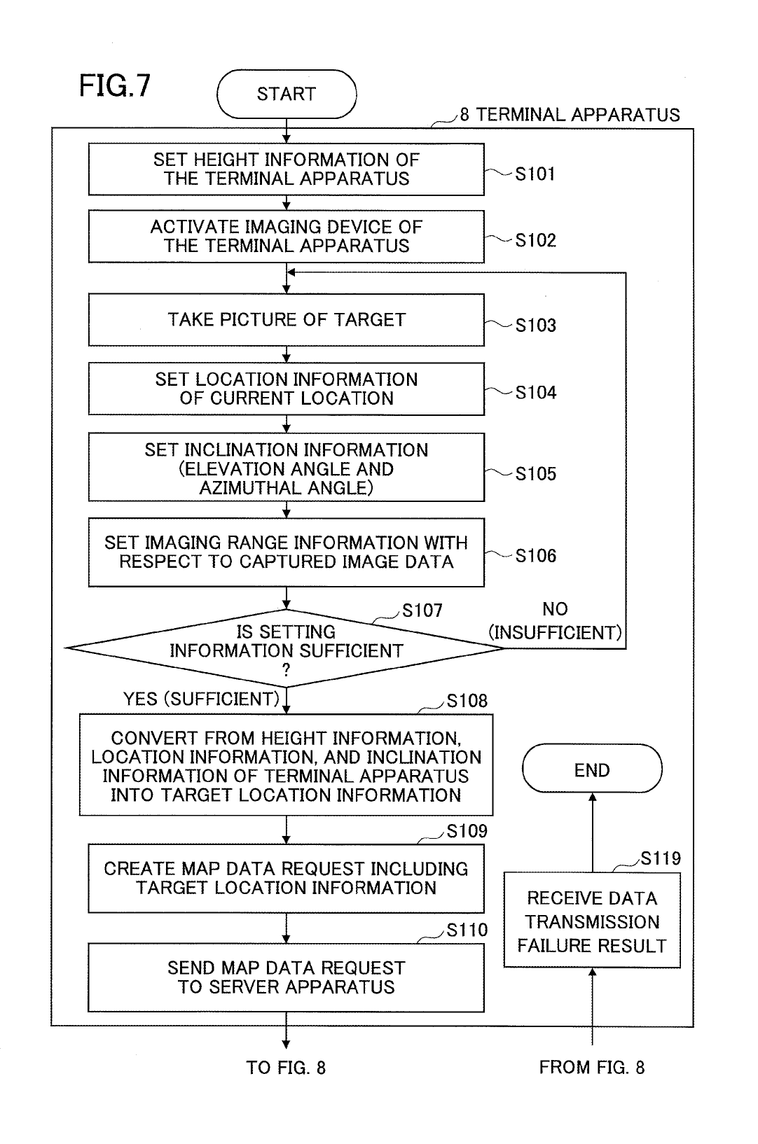

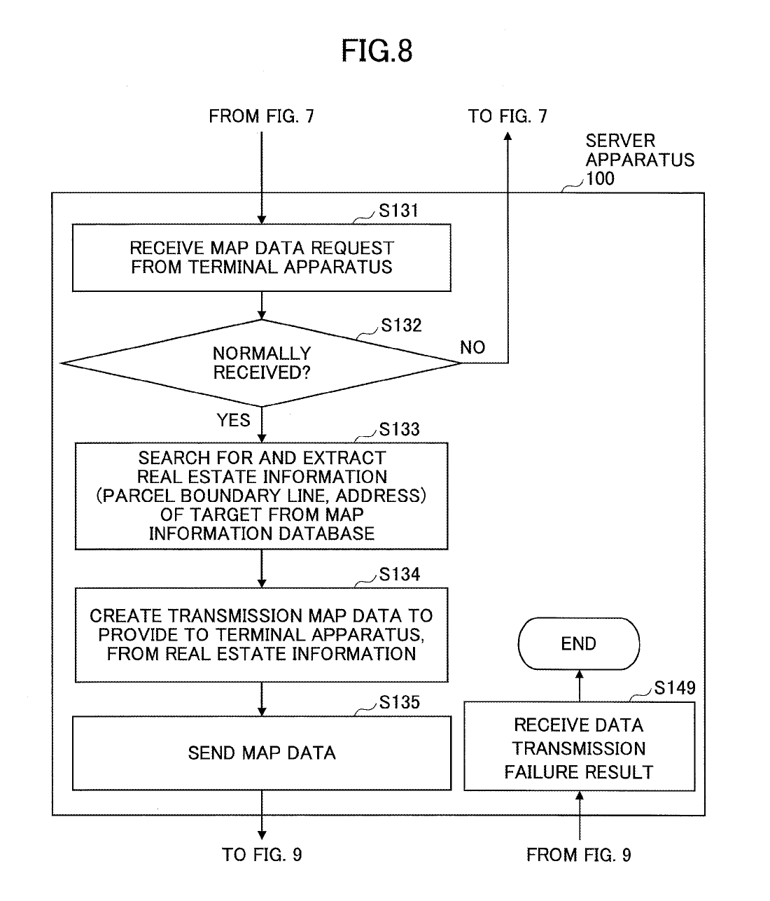

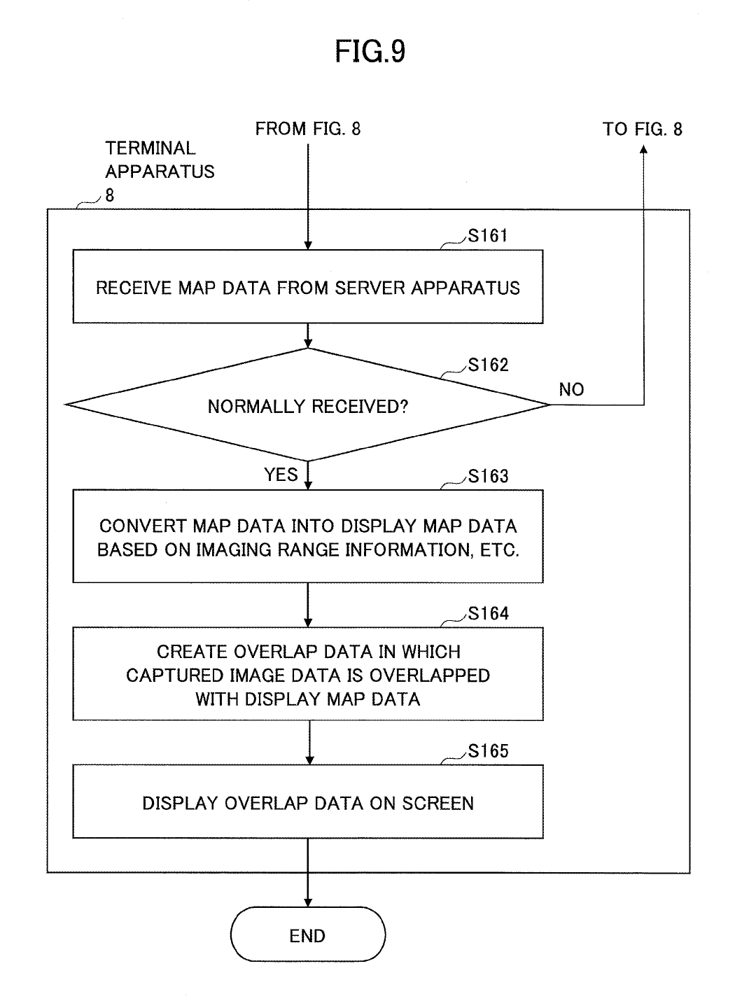

A real estate information overlapping process, which overlaps the real estate information onto the captured image, in the Embodiment 1 will be described with reference to FIG. 7, FIG. 8, and FIG. 9. In the Embodiment 1, the location coordinates of the target 4 at the terminal apparatus 8 is calculated, and the map data request is sent to the server apparatus 100.

FIG. 7 is a flowchart for explaining a process until the terminal apparatus requests the server apparatus the map data in the Embodiment 1 (part 1). In FIG. 7, in the terminal apparatus 8, the height setting part 52 sets the height information 72 of the terminal apparatus 8 (step S101). In response to the operation of the user 5, the imaging part 51 activates the imaging device 87 (step S102), and photographs the target 4 (step S103). The captured image data 71 are stored in the memory 81.

The location information setting part 55 sets the location information 74 of the current location (step S104). Also, the inclination setting part 54 sets the inclination information 75 indicating the elevation angle θ and the azimuthal angle φ (step S105). The imaging range setting part 53 sets the imaging range information 73 for the captured image data 71 (step S106). Then, it is determined whether the setting information is sufficient (step S107). If the setting information is not sufficient, the process goes back to step S103. The user 5 may retake the picture of the target 4, again. Then, the process is repeated in the same manner as described above. On the other hand, if the setting information is sufficient, the process advances to step S108.

The target location information conversion part 56 calculates the location coordinates of the target 4 by using the height information 72, the location information 74, the inclination information 75 indicating and the elevation angle θ and the azimuthal angle φ, and the like of the terminal apparatus 8 in order to convert from the location information 74 indicating the current location of the terminal apparatus 8 the target location information 76 indicating the location of the target 4 (step S108).

In order to request the map data to the server apparatus 100, the map data request part 57 creates the map data request including the target location information 76 which is converted from the location information 74 by target location information conversion part 56 (step S109). Information pertinent to the imaging range R may be further included in the map data request.

The data transmission part 58 sends the map data request to the server apparatus 100 (step S110). When transmission of the map data request to the server apparatus 100 has failed, the data transmission part 58 receives a data transmission failure result (step S119). The real estate information overlapping process is terminated. Alternatively, processes from step S102 may be repeated.

FIG. 8 is a flowchart for explaining a process until the server apparatus transmits the map data in response to the map data request in the Embodiment 1 (part 2). In FIG. 8, in the server apparatus 100, when the data reception part 41 receives the map data from the terminal apparatus 8, it is determined whether the map data request is normally received (step S132). If the map data request is not normally received, the data transmission failure result is sent to the terminal apparatus 8 (step S119 in FIG. 7). On the other hand, if the map data request is normally received, the process advances to step S133.

The real estate information acquisition part 43 retrieves the real estate information 91 of the target 4 by searching for the map information database 31 in the storage part 130 based on target location information 76 included in the map data request (step S133).

The transmission data creation part 44 creates the map data 77 by processing the real estate information 91 to form transmission data to provide to the terminal apparatus 8 (step S134). Then, the data transmission part 45 sends the map data 77 to the terminal apparatus 8 in response to a transmission request of the transmission data creation part 44 (step S135). When the map data 77 has failed to transmit to the terminal apparatus 8 and the data transmission failure result is received, after the data transmission part 45 has resent the map data 77 a predetermined times, the process at the server apparatus 100 is terminated.

FIG. 9 is a flowchart for explaining a process until the terminal apparatus sends the map data in response to the map data request in the Embodiment 1 (part 3). In FIG. 9, when the data reception part 61 receives the map data 77 from the server apparatus 100 (step S161), the terminal apparatus 8 determines whether the map data 77 are normally received (step S162). When the map data 77 are not normally received, the data transmission failure result is sent to the server apparatus 100 (step S149 in FIG. 8). On the other hand, when the map data 77 are normally received, the map data 77 are stored in the storage part 130, and this process advances to step S163.

The map data conversion part 62 converts the map data 77 by referring to the height information 72, the location information 74, the inclination information 75, and the target location information 76 of the terminal apparatus 8 to form a visual field based on the imaging range information 73 stored in the memory 81 and to depict the parcel boundary line and the address in a birds-eye view watching the target 4 from the terminal apparatus 8 (step S163).

The overlapping part 63 creates the overlap data 79 by overlapping the captured image data 71 with the display map data 78 (step S164). The overlap data 79 are stored in the memory 81.

The display process part 64 displays the overlap data 79 being stored in the memory 18 at the display part 83 (step S165). Then, the terminal apparatus 8 terminates the series of the real estate information overlapping process.

A functional configuration for overlapping the real estate information onto the captured image in an Embodiment 2 will be described. In the Embodiment 2, the server apparatus 100 conducts coordinates calculation of the target 4 photographed by the terminal apparatus 8.

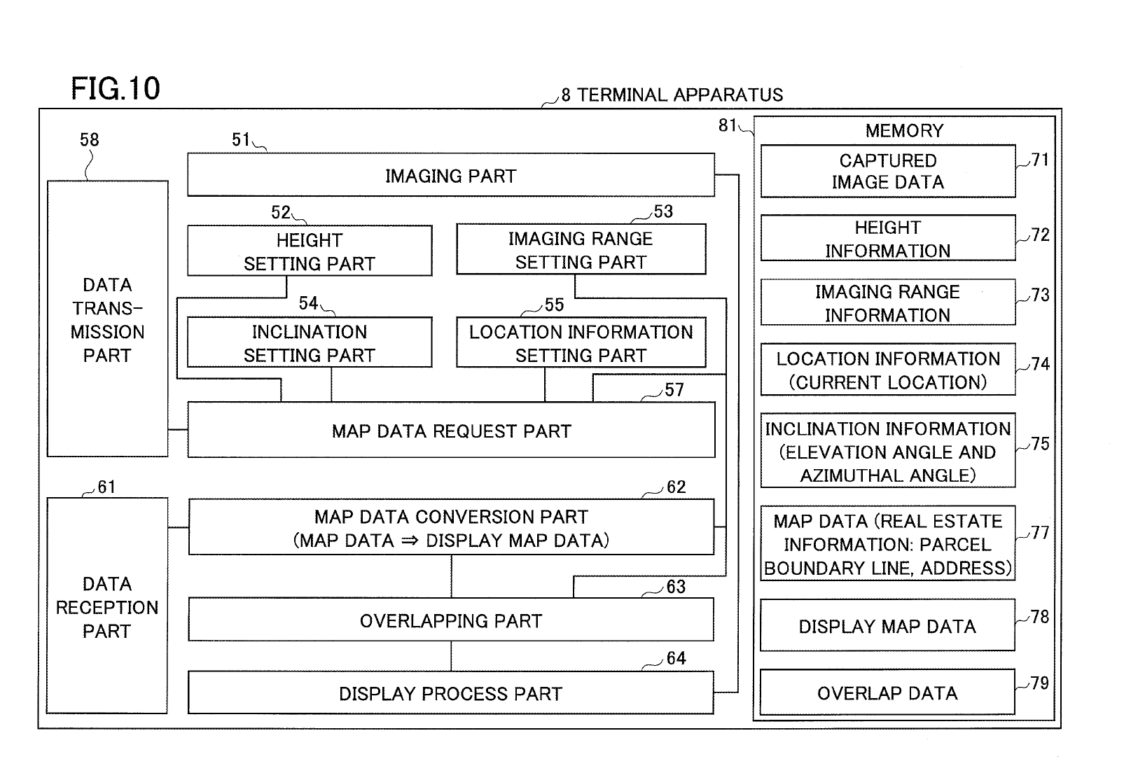

FIG. 10 is a diagram illustrating a functional configuration example of the terminal apparatus in the Embodiment 2. In FIG. 10, since the terminal apparatus 8 does not conduct the coordinates calculation of the target 4 in the Embodiment 2, the target location information conversion part 56 is omitted from the functional configuration of the terminal apparatus 8 in the Embodiment 1. Other parts that are the same as those in the Embodiment 1 are given by the same reference numbers, and the explanation thereof will be omitted.

In the Embodiment 2, since the target location information conversion part 56 in the Embodiment 1 is not included, the map data reception part 57 creates the map data request including the height information 72 and the location information 74 of the terminal apparatus 8, and the inclination information 75 when photographing the target 4, and sends the map data request to the server apparatus 100.

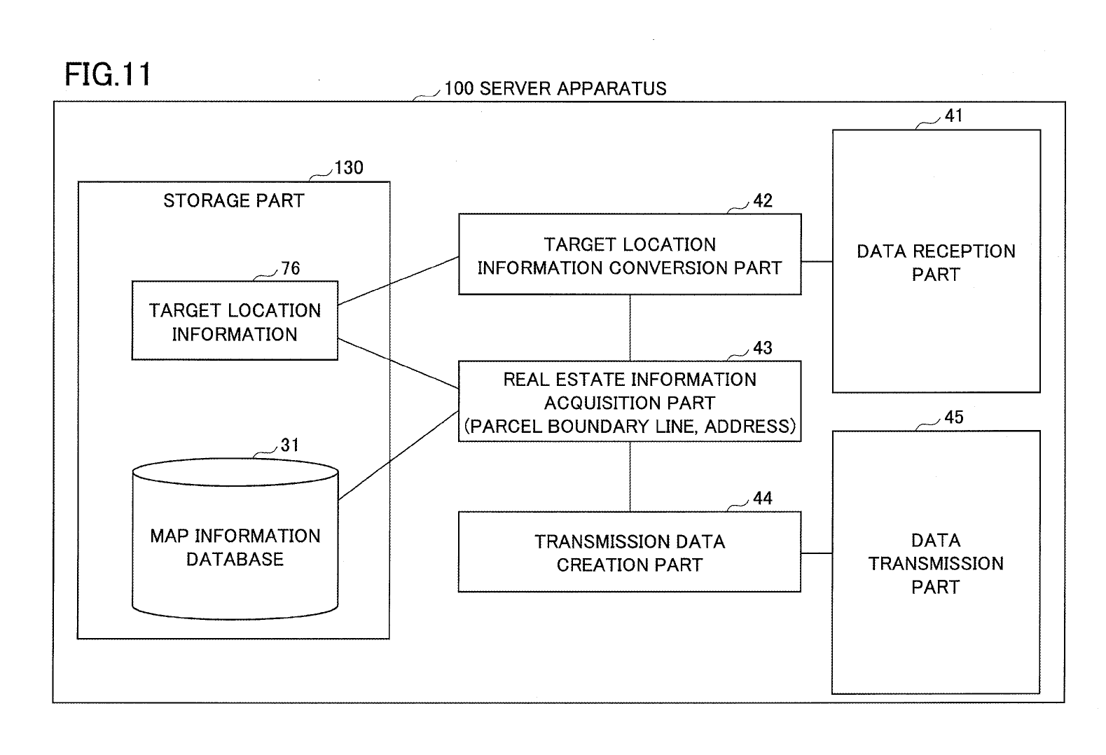

FIG. 11 is a diagram illustrating a functional configuration example of the server apparatus in the Embodiment 2. In FIG. 11, in the Embodiment 2, since the coordinates calculation of the target 4 is conducted by the server apparatus 100, the server apparatus 100 further includes a target location information conversion part 42 in addition to the functional configuration of the server apparatus 100 in the Embodiment 1. Other parts that are the same as those in the Embodiment 1 are given by the same reference numbers, and the explanation thereof will be omitted.

The target location information conversion part 42 acquires the height information 72 and the location information 74 of the terminal apparatus 8, and the inclination information 75 when photographing the target 4, from the map data request which the data reception part 41 receives from the terminal apparatus 8, and calculates the location of the target 4. The target location information 76 indicating the location of the target 4, which is calculated, is stored in the storage part 130.

The real estate information acquisition part 43 acquires the target location information 76 from the storage part 13, and acquires the parcel boundary line and the address from the map information database 31 stored beforehand in the storage part 130.

If the map data range to be acquired is indicated by the map data request, the map data are acquired based on the map data range. In a case in which the map data range is indicated by the map data request, the map data for the target 4 and the peripheral of the target 4 may be acquired by using the map data range defined beforehand. The real estate information acquisition part 43 reports the real estate information indicating the parcel boundary line and the address to the transmission data creation part 44 to request the map data 77.

The transmission data creation part 44 creates the map data 77 by processing the real estate information being reported to send in response to a transmission request from the real estate information acquisition part 43, and instructs the data transmission part 45 to send the map data 77 to the terminal apparatus 8.

The data transmission part 45 sends the map data 77 created by the transmission data creation part 44 to the terminal apparatus 8 to respond to the map data request.

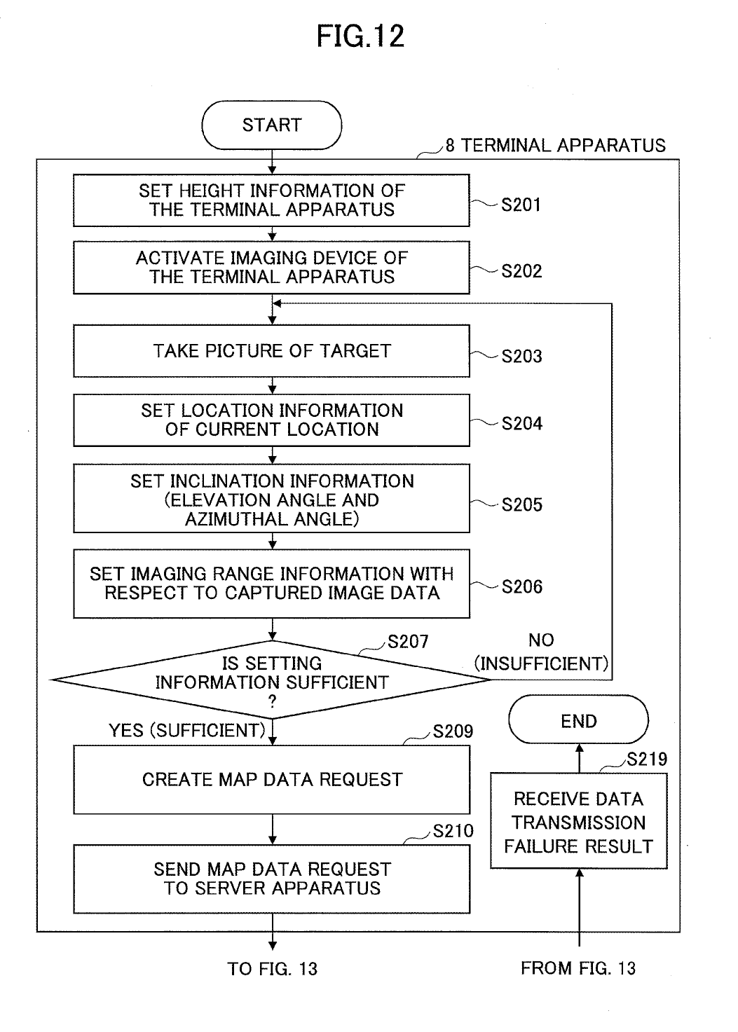

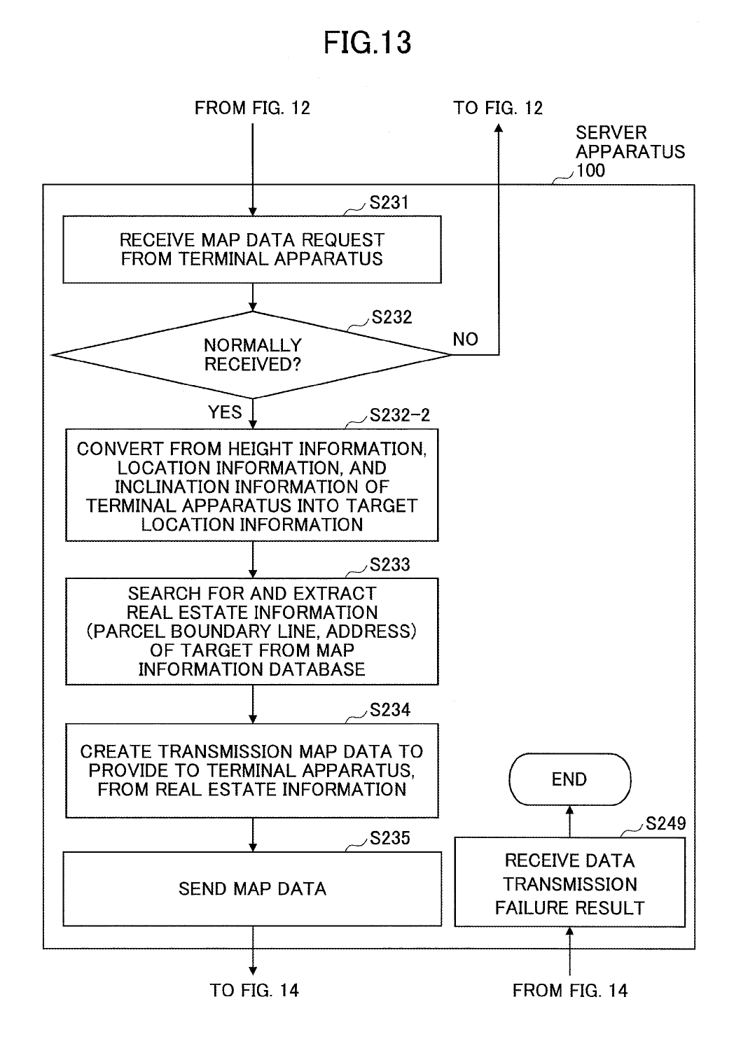

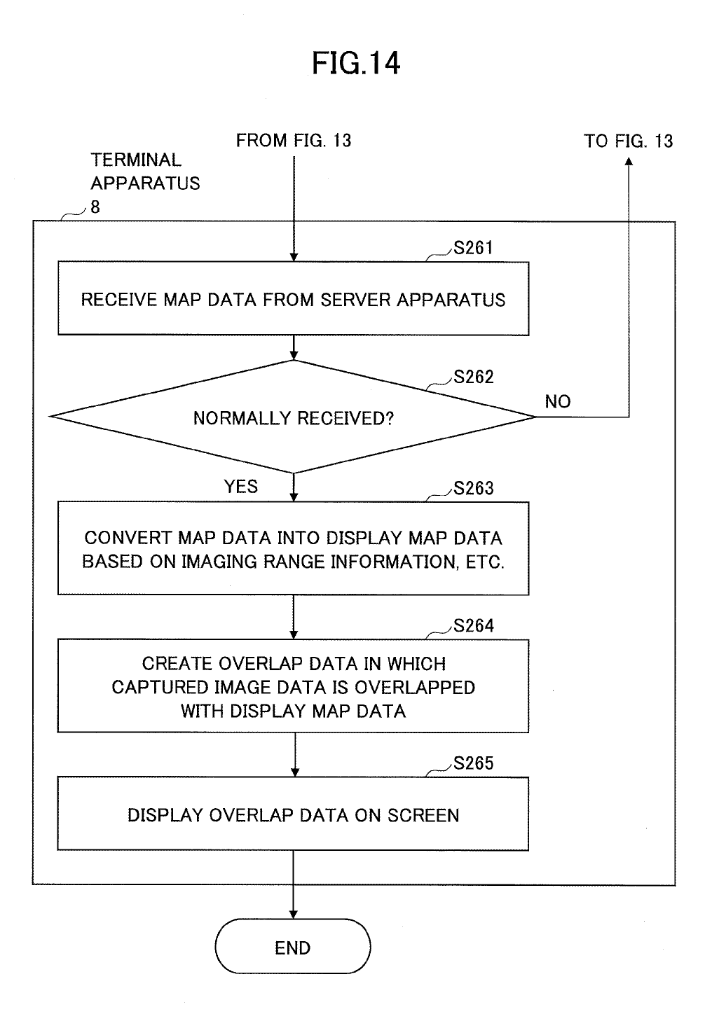

A real estate information overlapping process for overlapping the real estate information onto the captured image in the Embodiment 2 will be described with reference to FIG. 12, FIG. 13, and FIG. 14. In the Embodiment 2, the server apparatus 100 calculates the location coordinates of the target 4, and the map data are provided to the terminal apparatus 8.

FIG. 12 is a flowchart for explaining a process until the terminal apparatus requests the server apparatus the map data in the Embodiment 2 (part 1). In the terminal apparatus 8 in FIG. 12, the height setting part 52 sets the height information 72 of the terminal apparatus 8 (step S201). In response to the operation of the user 5, the imaging part 51 activates the imaging apparatus (step S202), and photographs the target 4 (step S203). The captured image data 71 are stored in the memory 81.

The location information setting part 55 sets the location information 74 of the current location (step S204). Also, the inclination setting part 54 sets the inclination information 75 indicating the elevation angle θ and the azimuthal angle φ (step S205). The imaging range setting part 53 sets the imaging range information 73 for the captured image data 71 (step S206). Then, it is determined whether the setting information is sufficient (step S207). When the setting information is not sufficient, the process goes back to step S203. The user 5 may retake the picture of the target 4, and the process is repeated in the same manner. On the other hand, when the setting information is sufficient, the process advances to step S209.

In the Embodiment 2, the terminal apparatus 8 does not perform a conversion process of the target location information.

The map data request part 57 creates the map data request which includes at least the height information 72 and the location information 74 of the terminal apparatus 8, and the inclination information 75 when photographing the target 4, in order to request the server apparatus 100 the map data (step S209). Information pertinent to the imaging range R may be further included in the map data request.

The data transmission part 58 sends the map data request to the server apparatus 100 (step S210). When the data transmission part 58 fails to transmit the map data request to the server apparatus 100, the data transmission part 58 receives the data transmission failure result (step S219). Then, the real estate information overlapping process is terminated. Alternatively, a process from step S202 may be repeated.

FIG. 13 is a flowchart for explaining a process until the server apparatus sends the map data in response to the map data request in the Embodiment (part 2). In the server apparatus 100 in FIG. 13, when the data reception part 41 receives the map data request from the terminal apparatus 8 (step S231), it is determined whether the data reception part 41 normally receives the map data request (step S232). When the data reception part 41 does not normally receive the map data request, the data transmission failure result is sent to the terminal apparatus 8 (step S219 in FIG. 12). On the other hand, when the data reception part 41 normally receives the map data request, the process advances to step S232-2.

The target location information conversion part 42 calculates the location coordinates of the target 4 by using the height information 72 and the location information 74 of the terminal apparatus 8, and the inclination information 75 indicating the elevation angle θ and the azimuthal angle φ so as to convert from the location information 74 indicating the current location of the terminal apparatus 8 to the target location information 76 indicating the location of the target 4 (step S232-2).

The real estate information acquisition part 43 retrieves the real estate information 91 of the target 4 by searching for the map information database 31 in the storage part 130 based on target location information 76 included in the map data request (step S233).

The transmission data creation part 44 creates the map data 77 by processing the real estate information 91 to form transmission data to provide to the terminal apparatus 8 (step S234). The data transmission part 45 sends the map data 77 in response to a transmission request of the transmission data creation part 44 (step S235). When the map data 77 has failed to send to the terminal apparatus 8 and the data transmission failure result is received, the process performed by the server apparatus 100 is terminated.

FIG. 14 is a flowchart for explaining a process until the terminal apparatus sends the map data in response to the map data request in the Embodiment 2 (part 3). In the terminal apparatus 8 in FIG. 14, when the data reception part 61 receives the map data 77 (step S261), it is determined whether the data reception part 61 normally receives the map data 77 (step S262). When the data reception part 61 does not normally receive the map data 77, the data transmission failure result is sent to the server apparatus 100 (step S249 in FIG. 13). On the other hand, when the data reception part 61 normally receives the map data 77, the map data 77 are stored in the storage part 130. Then, the process advances to step S263.

The map data conversion part 62 converts the map data 77 by referring to the height information 72, the location information 74, the inclination information 75, and the target location information 76 of the terminal apparatus 8 to form a visual field based on the imaging range information 73 stored in the memory 81 and to depict the parcel boundary line and the address in a birds-eye view watching the target 4 from the terminal apparatus 8 (step S263).

The overlapping part 63 creates the overlap data 79 by overlapping the captured image data 71 with the display map data 78 (step S264). The overlap data 79 are stored in the memory 81.

The display process part 64 displays the overlap data 79 being stored in the memory 18 at the display part 83 (step S265). Then, the terminal apparatus 8 terminates the series of the real estate information overlapping process.

In the following, result examples of the real estate information overlapping process in the Embodiments 1 and 2 will be described.

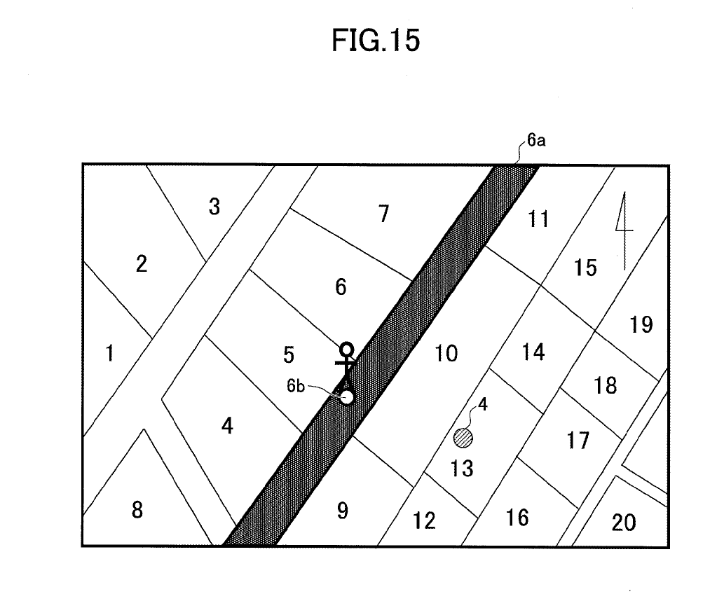

FIG. 15 is a diagram illustrating an example of the plan view. In FIG. 15, a case of drawing the map at the display part 83 in which a current location 6b of the user 5 (the terminal apparatus 8) is positioned at a center. The current location 6b is specified by location information acquired from the GPS. In this case, an observing direction of the user 5 is not considered. As a result, it is difficult to readily comprehend the real estate information of the target 4.

When a peripheral map, in which the current location 6b is positioned at the center, is drawn on the plan view, the user 5 comprehends a location of the user 5 on a road 6a, and determines an orientation of the target 4. Then, based on a distance from the user 5 to the target 4, which is acquired by a sense of distance, the user 5 determines the address closer the target 4 on the plan view. Thus, experience and knowledge are demanded to properly determine the address and the parcel boundary line of the target 4.

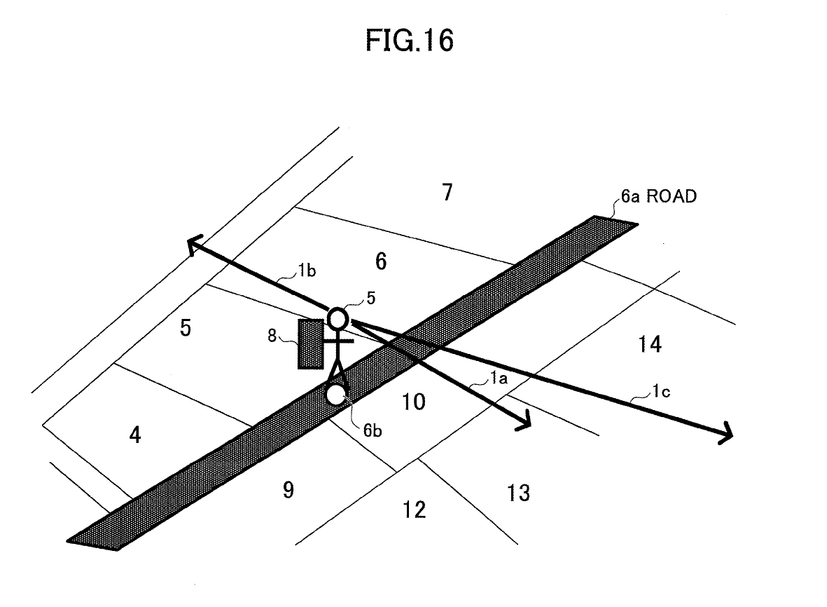

FIG. 16 is a diagram illustrating an example of the birds-eye view. In FIG. 16, a case of drawing, at the display part 83, the birds-eye view in which a map defining the current location of the user 5 (the terminal apparatus 8) at the center, is depicted. The current location 6b is specified by the location information acquired from the GPS. In this example, since the observing direction of the user 5 is not considered, it is difficult to readily comprehend the real estate information of the target 4 similar to the plan view in FIG. 15 in which the user 5 is positioned at the center.

In any of observing directions 1a, 1b, and 1c of the user 5, a similar map is drawn for the peripheral map positioning the user 5 at the center. As a result, it is not easy to comprehend the real estate information of the target 4. Depending on a display state, the real estate information of the target 4 in the observing direction of the user 5 may not be displayed (for the observing directions 1b and 1c).

The observing direction 1a corresponds to a case in which the user 5 takes, by the terminal apparatus 8, the picture of a close view in front of the user 5. The observing direction 1b corresponds to a case in which the user 5 looks back and takes, by the terminal apparatus 8, the picture of another close view. The observing direction 1c corresponds to a case in which the user 5 takes a picture of a distant view in front of the user 5.

In the Embodiments 1 and 2, if the target 4 is positioned in the observing direction 1a, 1b, or 1c of the user 5, the map data 77 depending on the observing direction 1a, 1b, or 1c are overlapped with the captured image data 71. Therefore, it is possible to associate the target 4 with the real estate information.

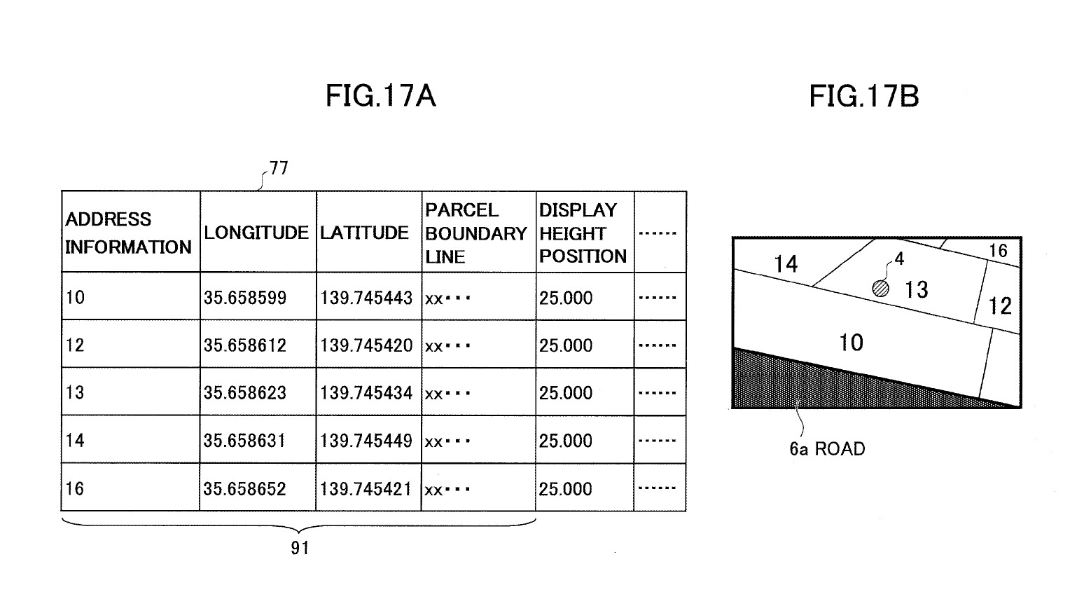

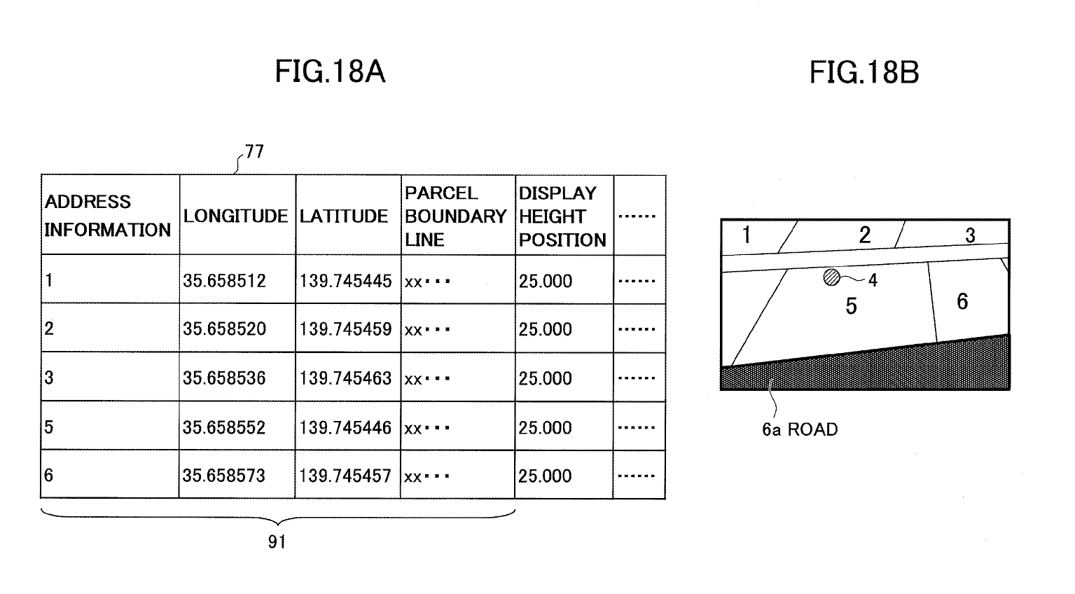

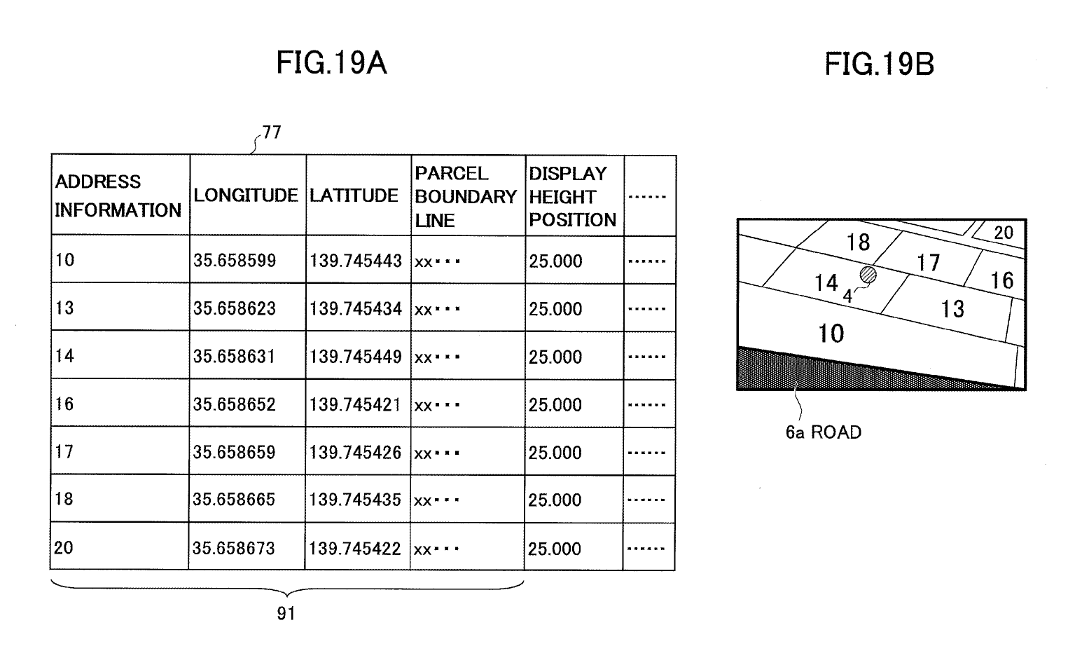

Data examples and display examples will be described with reference to FIG. 17, FIG. 18, and FIG. 19. The data examples are related to the map data 77 which are acquired depending on the observing direction 1a, 1b, and 1c. The display examples are related to the real estate information 91 pertinent to the target 4.

FIG. 17A and FIG. 17B are diagrams illustrating example results of the real estate information overlapping process with respect to the close view in front of the user at the same location. In FIG. 17A, a data example of the map data 77 is illustrated in a case in which the user 5 takes the picture of the target 4 in the observing direction 1a in FIG. 16. In FIG. 17B, a screen example, in which the display map data 78 based on the map data 77 are overlapped with the captured image data 71, is illustrated.

In the data example of the map data 77 depicted in FIG. 17A, the real estate information 91 within the visual field and information of a display height location and the like are indicated in a case in which the user 5 (the terminal apparatus 8) positioned on the road 6a looks at the target 4 in the observing direction 1a, and in the imaging range R based on the imaging range information 73.

For each set of address information “10”, “12”, “13”, “14”, and “16” within the visual field in the observing direction 1a, the longitude and latitude, the parcel boundary line, the display height location, and the like are associated with the map data 77.

In the screen example depicted in FIG. 17B, each set of address information “10”, “12”, “13”, “14”, and “16” is displayed. Accordingly, it is possible for the user 5 to determine that the address of the target 4 is an address “13”. Also, when displaying the address information, the parcel boundary line may be overlapped with the captured image data 17 and be displayed. In this case, it is possible for the user 5 to precisely comprehend the location of the target 4, since the parcel boundary line is displayed.

FIG. 18A and FIG. 18B are diagrams illustrating example results of the real estate information overlapping process with respect to another close view when the user looks back at the same location. In FIG. 18A, a data example of the map data 77 is illustrated in a case in which the user 5 takes the picture of the target 4 by the terminal apparatus 8 in the observing direction 1b in FIG. 16. In FIG. 18B, a screen example is illustrated in a case in which the display map data 78 based on the map data 77 are overlapped with the captured image data 71.

In the data example of the map data 77 depicted in FIG. 18A, the real estate information 91 within the visual field and information of a display height location and the like are indicated in a case in which the user 5 (the terminal apparatus 8) positioned on the road 6a looks at the target 4 in the observing direction 1b, and in the imaging range R based on the imaging range information 73.

For each set of address information “1”, “2”, “3”, “5” and “6” within the visual field in the observing direction 1b, the longitude and latitude, the parcel boundary line, the display height location, and the like are associated with the map data 77.

In the screen example depicted in FIG. 18B, each set of address information “1”, “2”, “3”, “5” and “6” is displayed, and the parcel boundary line is overlapped with the captured image data 71. Accordingly, it is possible for the user 5 to easily determine that the target 4 is located in an area of an address “4”.

FIG. 19A and FIG. 19B are diagrams illustrating example results of the real estate information overlapping process with respect to the distant view in front of the user at the same location. In FIG. 19A, a data example of the map data 77 is illustrated in a case in which the user 5 takes the picture of the target 4 by the terminal apparatus 8 in the observing direction 1c in FIG. 16. In FIG. 18B, a screen example is illustrated in a case in which the display map data 78 based on the map data 77 are overlapped with the captured image data 71.

In the data example of the map data 77 depicted in FIG. 19A, the real estate information 91 within the visual field and information of a display height location and the like are indicated in a case in which the user 5 (the terminal apparatus 8) positioned on the road 6a looks at the target 4 in the observing direction 1c, and in the imaging range R based on the imaging range information 73.

For each set of address information “10”, “13”, “14”, “16”, “17”, “18”, and “20” within the visual field in the observing direction 1c, the longitude and latitude, the parcel boundary line, the display height location, and the like are associated with the map data 77.

In the screen example depicted in FIG. 19B, each set of address information “10”, “13”, “14”, “16”, “17”, “18”, and “20” is displayed, and the parcel boundary line is overlapped with the captured image data 71. Accordingly, it is possible for the user 5 to easily determine that the target 4 is located in an area of an address “14”.

As described above, in the Embodiments 1 and 2, instead of using the map data based on the location information acquired from the GPS, the map data based on the location information of the target 4 are converted into data to depict the target 4 as viewed from the location of the user 5 (the terminal apparatus 8) in the observing direction, and are overlapped with the captured image data 71 photographing the target 4. It is possible for the user 5 to precisely and easily determine the parcel boundary line and the address of the area where the target 4 is located.

The server apparatus 100 may be simply provided with the map information in conformity with the Real Estate Registration Act. Hence, the server apparatus 100 may not be implemented with a scheme for combining various sets of the map information.

As described above, according to the Embodiments 1 and 2, when the terminal apparatus 8 including an imaging function conducts an imaging process, by specifying an area corresponding to the plot of land within the captured image, it is possible to display a boundary of the plot of land on the captured image.

Therefore, when the imaging process is executed by the terminal apparatus 8 including the imaging function, by specifying an area corresponding to the plot of land in the captured image, it is possible to overlap and display the boundary of the plot of land with the captured image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a program which, when executed by a computer, causes the computer to perform a plot of land boundary display process comprising:
executing an imaging process when an imaging request is detected;
specifying an imaging range based on a location, an imaging orientation and an elevation angle of a terminal apparatus when the imaging process is executed;
specifying an area corresponding to a plot of land in a captured imaged based on the imaging range being specified;
reading out boundary line information of the plot of land corresponding to latitude and longitude information from a storage part;
generating an image by overlapping the area being specified with the boundary line information being read out; and
displaying the image at a display device.

2. The non-transitory computer-readable recording medium as claimed in claim 1, further comprising:
reading out address information specifying the area from the storage part; and
overlapping the address information in the image.

3. The non-transitory computer-readable recording medium as claimed in claim 1, further comprising converging from the location, the elevation angle, and an azimuthal angle of the terminal apparatus to the location of the plot of land included in the imaging range,
wherein the location of the plot of land corresponds to the latitude and longitude information.

4. The non-transitory computer-readable recording medium as claimed in claim 1, wherein the boundary line information of the plot of land corresponding to the latitude and longitude information is acquired from an external database, and is stored in the storage part.

5. A land boundary display method performed in a computer, the method comprising:
executing an imaging process when an imaging request is detected;
specifying an imaging range based on a location, an imaging orientation and an elevation angle of a terminal apparatus when the imaging process is executed;
specifying an area corresponding to a plot of land in a captured imaged based on the imaging range being specified;
reading out boundary line information of the plot of land corresponding to latitude and longitude information from a storage part;
generating an image by overlapping the area being specified with the boundary line information being read out; and
displaying the image at a display device.

6. A terminal apparatus including an imaging function, the terminal apparatus comprising:
a processor; and
a storage device;
wherein the processor includes:
an imaging process part configured to execute an imaging process when an imaging request is detected;
an imaging range setting part configured to set an imaging range based on a location, an imaging orientation and an elevation angle of a terminal apparatus when the imaging process is executed;
a specifying part configured to specify an area corresponding to a plot of land in a captured imaged based on the imaging range being specified;
an overlapping part configured to read out boundary line information of the plot of land corresponding to latitude and longitude information from a storage device, and generate an image by overlapping the area being specified with the boundary line information being read out; and
a displaying part configured to displaying the image at a display device.

7. A system in which a terminal apparatus including an imaging device and a server apparatus including a storage unit in which a database retaining map data are stored, wherein
the terminal apparatus sends a map data request for requesting the map data of a target photographed by the imaging device,
the server apparatus acquires the map data including real estate information of a plot of land from the database based on location information of the target photographed by the imaging device, the location information acquired from the map data request, in response to the map data request, and sends the map data to the terminal apparatus, and
the terminal apparatus overlaps the real estate information of the map data received from the server apparatus with an image of the target captured by the imaging device, and displays the image at a display device.

8. The system as claimed in claim 7, wherein
the real estate information includes at least parcel boundary line information of the target, and
the image of the target is overlapped with the parcel boundary line information, and is displayed at the display device of the terminal apparatus.

9. The system as claimed in claim 8, wherein
the real estate information further includes address information of the target, and
the image of the target is overlapped with the parcel boundary line information and the address information, and is displayed at the display device of the terminal apparatus.

10. The system as claimed in claim 7, wherein when sending the map data request to the server apparatus, the terminal apparatus calculates a location of the target based on a location, height, and inclination information of the terminal apparatus, and sends the map data request including location information indicating the location of the target to the server apparatus.

11. The system as claimed in claim 7, wherein
the terminal apparatus includes the location, the height, and the inclination information of the terminal apparatus in the map data request, and sends the map data request to the server apparatus, and
the server apparatus calculates the location of the target based on the location, the height, and the inclination information of the terminal apparatus which are acquired from the map data request, acquires the map data including the real estate information of the target from the database based on the location information indicating the location of the target, and sends the map data to the server apparatus.
